(19) United States
(12) Patent Application Publication
(10) Pub. No.: US 2014/0108294 A1
(43) Pub. Date: Apr. 17, 2014

(54) METHOD AND APPARATUS FOR ANALYSIS AND MAPPING OF HEDGE FUND INVESTMENT STRATEGIES

(71) Applicant: iFiMobile, Inc., Pleasanton, CA (US)

(72) Inventor: Nicholas KHABBAZ, Danville, CA (US)

(73) Assignee: iFiMobile, Inc., Pleasanton, CA (US)

(21) Appl. No.: 14/046,735

(22) Filed: Oct. 4, 2013

Related U.S. Application Data
(60) Provisional application No. 61/710,615, filed on Oct. 5, 2012.

(51) Int. Cl. G06Q 40/06

(52) U.S. Cl. CPC G06Q 40/06
USPC 705/36 R

(57) ABSTRACT

Techniques are provided that systematically deconstruct any fund investment strategy into precise elements along multiple, orthogonal dimensions such that such fund investment strategy can be uniquely and meaningfully mapped as a point or locus of points in a multi-dimensional space, thereby producing a strategy map. This can be done alone or in conjunction with other such strategy maps and such that the relative overlap and complementation of a collection of the strategy maps can be readily and automatically determined with a reasonable degree of precision. In particular, an application to hedge funds and their associated hedge fund investment strategies is provided.

### CROSS REFERENCE TO RELATED APPLICATIONS

This patent application claims priority from U.S. provisional patent application Ser. No. 61/710,615, METHOD FOR THE ANALYSIS AND MAPPING OF HEDGE FUND INVESTMENT STRATEGIES, filed Oct. 5, 2012, the entirety of which is incorporated herein by this reference thereto.

### BACKGROUND OF THE INVENTION

1. Technical Field

This invention relates generally to the field of computer related techniques for the investment fund industry. More specifically, this invention relates to computer related techniques for the hedge fund segment of the investment fund industry.

2. Description of the Related Art

In recent years, hedge funds have become increasingly important investment vehicles for institutional investors, such as for example pension funds, university endowments, foundations, family offices, and international banks. Hedge funds are distinguished from other investment funds in part by the diverse range of assets in which they invest, as well as by the range of investment strategies which they employ. Hedge funds are noted for attempting to produce positive returns in both rising and falling markets.

Investors typically select a portfolio of hedge funds in which to invest based on multiple factors including fund management, history, and perhaps most notably investment strategy. Hedge funds publish, and are generally held accountable for operating according to, specific named investment strategies. Examples of such named investment strategies are provided in Table 1.

TABLE 1

| | |
|---|---|
| 1. | Asian Equity Long |
| 2. | Asian Fixed Income |
| 3. | Chinese Equity |
| 4. | Commodity Funds |
| 5. | Diversified Arbitrage |
| 6. | Emerging Markets Debt |
| 7. | Emerging Markets Equity Long/Short |
| 8. | Emerging Markets Fixed Income |
| 9. | Emerging Markets - Asia |
| 10. | Equity Long |
| 11. | Equity Long/Short |
| 12. | European Equity |
| 13. | European Multi Strategy |
| 14. | Event Driven |
| 15. | Fixed Income Arbitrage |
| 16. | Global Equity Long/Short |
| 17. | Global Fixed Income |
| 18. | Global Macro |
| 19. | Global Multi Strategy |
| 20. | Indian Equity |
| 21. | Latin American Equity |
| 22. | Mortgage-Backed Securities |
| 23. | UK Listed |
| 24. | US Equity Long |
| 25. | Volatility Trading |

An important goal in assembling a hedge fund portfolio is the selection of a complementary spectrum of investment strategies such that the overall portfolio risk/return is optimized under the broadest range of market conditions. Maintaining this investment strategy balance is generally regarded as essential because hedge funds tend to be illiquid, dynamic, and heterogeneous in nature.

Conversely, hedge fund managers are also continuously scanning the spectrum of investment strategies seeking new strategic opportunities and thereby creating hedge funds with new investment strategies. From both a market and an operational standpoint, such managers are thus very sensitive to a fine grained understanding of how an investment strategy fits into said spectrum.

In many instances, the name of an investment strategy is indicative of certain key aspects of the investment strategy itself, e.g. ‘Emerging Markets/Distressed.’ However, the name by itself is rarely expressive enough to determine where a particular hedge fund investment strategy fits into said spectrum. In conventional known art, hedge fund investment strategies are often broken down into four categories:
Global Macro;
Directional;
Event Driven; and
Relative Value.

It would be advantageous to provide a method and apparatus that addresses the above-mentioned limitations.

### SUMMARY OF THE INVENTION

Techniques are provided that systematically deconstruct any fund investment strategy into precise elements along multiple, orthogonal dimensions such that such fund investment strategy can be uniquely and meaningfully mapped as a point or locus of points in a multi-dimensional space, thereby producing a strategy map. This can be done alone or in conjunction with other such strategy maps and such that the relative overlap and complementation of a collection of the strategy maps can be readily and automatically determined with a reasonable degree of precision. In particular, an application to hedge funds and their associated hedge fund investment strategies is provided.

### BRIEF DESCRIPTION OF THE DRAWINGS

FIG. 1 is a schematic diagram of investment strategy dimensions, according to an embodiment of the invention;

FIG. 2 is a schematic diagram of a domain hierarchy, according to an embodiment of the invention;

FIG. 3 is a schematic diagram of an example of a domain detailed structure, according to an embodiment of the invention;

FIG. 4 is a schematic diagram of an example of a strategic approach detailed structure, according to an embodiment of the invention;

FIG. 5 is a schematic diagram of an example of a transactional detailed structure, according to an embodiment of the invention;

FIG. 6 is a schematic diagram of a conceptual view of portfolio rebalancing, according to an embodiment of the invention;

FIG. 7 is a flow diagram of an overview of a portfolio rebalancing process, according to an embodiment of the invention;

FIG. 8 is a flow diagram of a portfolio optimizer process overview, according to an embodiment of the invention; and

FIG. 9 is a block schematic diagram of a system in the exemplary form of a computer system according to an embodiment.

### DETAILED DESCRIPTION OF THE INVENTION

While hedge fund investment strategies are often broken down into the four categories mentioned above, it should be appreciated that such categories are not orthogonal, or mutually exclusive, in nature so that many fund investment strategies do not fit uniquely into a single category. Moreover these are extremely coarse grained characterizations leading to the lumping together of very different types of investment strategies. Thus, investors and hedge fund managers are both left to imprecise methods to determine the relative complementation of a collection of hedge fund investment strategies.

An embodiment of the invention systematically deconstructs any fund investment strategy into precise elements along multiple, orthogonal dimensions such that such fund investment strategy can be uniquely and meaningfully mapped as a point or locus of points in a multi-dimensional space, thereby producing a strategy map. This can be done alone, or in conjunction with other such strategy maps and such that the relative overlap and complementation of a collection of said strategy maps can be readily and automatically determined with a reasonable degree of precision.

An embodiment of the invention may be applied to any type of investment fund and associated investment strategy. However, particular embodiments as described herein are concerned with the application to hedge funds and their associated hedge fund investment strategies.

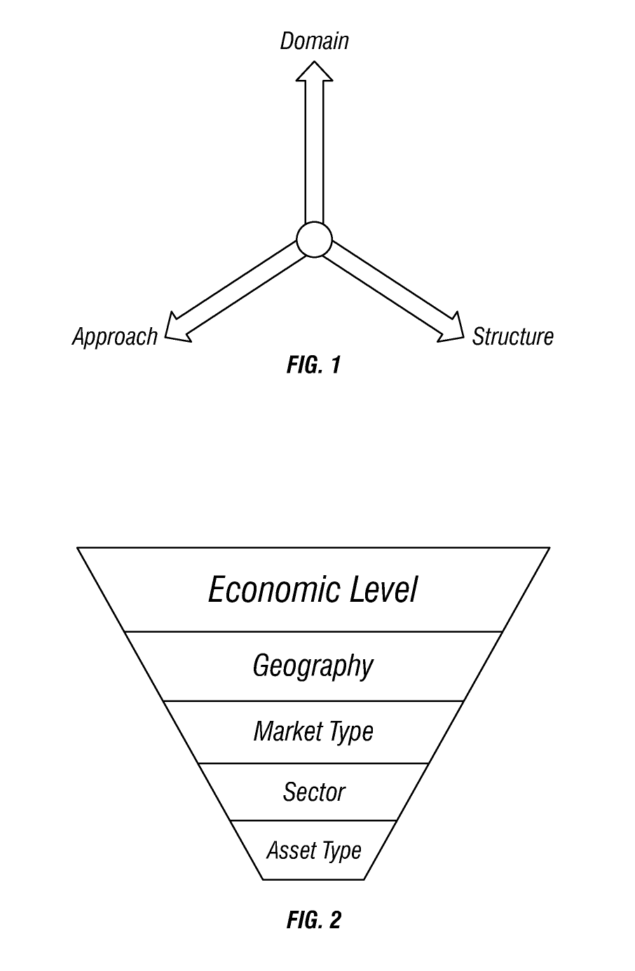

In an embodiment, a set of axes may be selected to define the multi-dimensional space. Several such selections are possible. One embodiment of the invention uses three such coordinate axes as shown in FIG. 1, listed and defined below:
Domain: characterizes the target subject matter or scope of a fund's investments;
Strategic Approach: characterizes the target situational aspects driving a fund's investments; and
Transactional Structure: characterizes the specific asset structure targeted for acquisition/disposal by a fund.

Within each of the three axes, an investment strategy may be characterized by a point or a configuration of points as detailed in the sections which follow.

### The Domain Axis

In an embodiment, the domain axis configuration is defined at two levels. At the top level is an array of domain categories which, in a preferred embodiment, includes but is not limited to:
Economic Level;
Geography;
Market Type;
Sector; and
Asset Type.

These categories pertain to the material subject matter or scope of a hedge fund investment strategy and answer the question “where do I invest.” In an embodiment, the domain categories naturally arrange themselves in a narrowing hierarchy of specification as illustrated in FIG. 2.

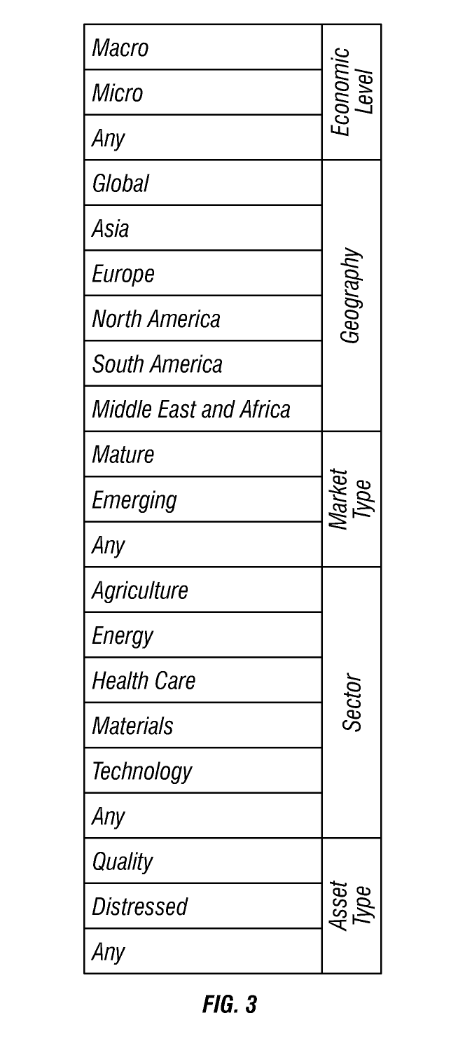

In an embodiment, within a domain space configuration of an investment strategy, each category must have a specific value or configuration. An example of a breakdown of the domain categories into specific values is shown in FIG. 3.

### The Strategic Approach Axis

In an embodiment, the strategic approach axis pertains to the environmental considerations or market events which may determine or trigger investment or divestment activity on the part of the hedge fund. This axis is responsive to the question “when, or under what circumstances do I buy or sell.”

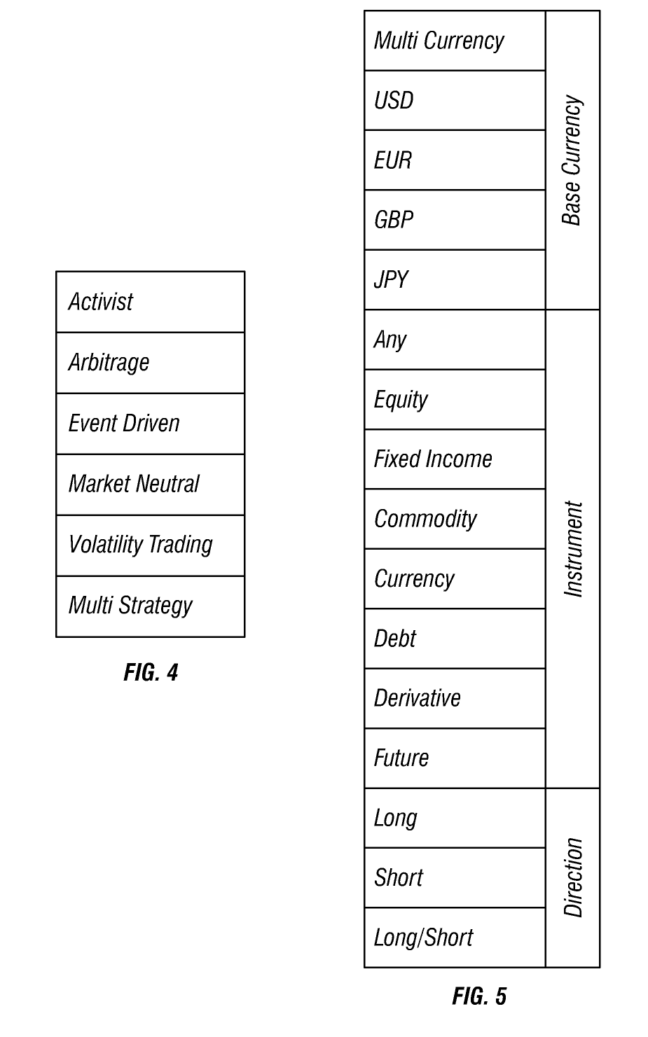

In an embodiment, configurations along the approach axis may be but are not limited to being single valued and in one embodiment correspond to one of the values shown in the detailed structure in FIG. 4.

### The Transaction Structure Axis

In an embodiment, the transactional structure axis pertains to the structure of the actual assets or securities being acquired in the exercise of an investment strategy. Values on this axis are responsive to the question “what and how do I actually trade.”

In an embodiment and as in the case of the Domain axis, configurations in the structure axis are but are not limited to being multi-level and multi-value in nature. In an embodiment, at the top level is an array of structure categories each of which takes a value. These are but are not limited to:
base currency;
instrument; and
direction.

An example of a breakdown of the transaction structure categories into specific values is shown in FIG. 5. For example, each fund category value may have a second level of values such as but not limited to:
all available currencies, any, multi-currency, USD, EUR, GBP, JPY, etc., for base currency;
all available instruments, any, equity, fixed income, commodity, currency, debt, derivative, future, etc., for instrument; and
long, short, and long/short for direction.

### Applications

Embodiments may be applied in many ways, including but not limited to exemplary applications, Portfolio Analysis and Portfolio Rebalancing and Optimization described below.

### Portfolio Analysis

In one application in accordance with an embodiment, an investor has an existing hedge fund portfolio containing a current allocation. The current allocation provides a list of hedge funds and an amount invested in each one. Each hedge fund has an associated investment strategy which may be mapped according to an embodiment to an investment strategy map. As an example, consider a hedge fund which has an associated investment strategy of type “Global Equity Long/Short” This investment strategy corresponds to the following investment strategy map:
Domain
   Economic level=Any
   Geography=Global
   Market type=Any
   Sector=Any
   Asset Type=Any
Approach
   Multi-Strategy
Structure
   Currency=Multi Currency
   Instrument=Equity
   Direction=Long/Short

In an embodiment, a Fund Investment Strategy Map Assignment (Fund “ISMA”) is derived by assigning the current investment in that fund to each of the category values. For example when the investment in the above hedge fund is $2,500,000, then the Fund ISMA is:
Domain
   Economic Level: Any=$2,500,000
   Geography: Global=$2,500,000
   Market Type: Any=$2,500,000
   Sector: Any=$2,500,000
   Asset Type: Any=$2,500,000
Approach
   Multi-Strategy=$2,500,000
Structure
   Currency: Multi Currency=$2,500,000
   Instrument: Equity=$2,500,000
   Direction: Long/Short=$2,500,000

In an embodiment, a Portfolio Investment Strategy Map Assignment (“Portfolio ISMA”) is the aggregate of Fund ISMAs for all funds in a portfolio. The Portfolio ISMA can be expressed in either currency ($) value or percentage terms. An example of a Portfolio ISMA expressed in percentage terms is illustrated below:
Domain
   Economic Level
      Macro=22%
      Micro=23%
      Any=55%
   Geography
      Global=12%
      Asia=14%
      Europe=18%
      North America=31%
      South America=25%
   Market Type
      Mature=22%
      Emerging=56%
      Any=22%
   Sector
      Energy=32%
      Technology=34%
      Health Care=10%
      Any=24%
   Asset Type
      Quality=51%
      Distressed=12%
      Any=37%
Approach
   Arbitrage=10%
   Event Driven=22%
   Market Neutral=13%
   Volatility Trading=8%
   Multi Strategy=47%
Structure
   Base Currency
      USD=42%
      EUR=30%
      GPY=28%
   Instrument
      Equity=44%
      Fixed Income=29%
      Debt=17%
      Derivative=10%
   Direction
      Long=68%
      Short=21%
      Long/Short=11%

In an embodiment, the Portfolio ISMA shows a breakdown of the portfolio in each of its relevant categories. Therefore, it provides an investor with a clear view of the exposure of the portfolio in each category. For example, based on the above Portfolio ISMA, the investor may derive that, given expected market conditions, the following may be desirable:
Less exposure to the Technology sector and more exposure to other sectors;
A more market neutral investment strategy; and
Increased hedging against a market decline.

### Portfolio Rebalancing and Optimization

In a different application and in accordance with an embodiment, an Investor or any other user may desire to create a proposed allocation of hedge funds, which provides a set of recommendations for changes to the current portfolio allocation so as to rebalance and/or optimize the allocation according to the investor's goal. For example, the Investor may have as a goal one or more of the following:
Diversification: The Investor finds that the original diversification requirement criteria no longer hold. The Investor would therefore like to rebalance the portfolio by reducing, increasing, or eliminating the exposure to certain markets, sectors, or currencies to bring the diversification back to the original requirements.
Portfolio Hedging: Similarly, based on new or unexpected risk exposures, the Investor would like to rebalance the portfolio funds in order to re-establish the required hedging strategies.
Volatility: The Investor finds that the volatility of the portfolio as a whole is increased due to increased market volatilities of a subset of the portfolio funds. The Investor would like to introduce new strategies or reduce exposure to existing strategies. Alternatively, the Investor may want to increase volatility, in certain areas of focus with the hope to achieve better overall portfolio performance.
Performance: Based on expected performance of different funds in the portfolio, the Investor would like to introduce new strategies and/or increase or reduce the exposure to other strategies.

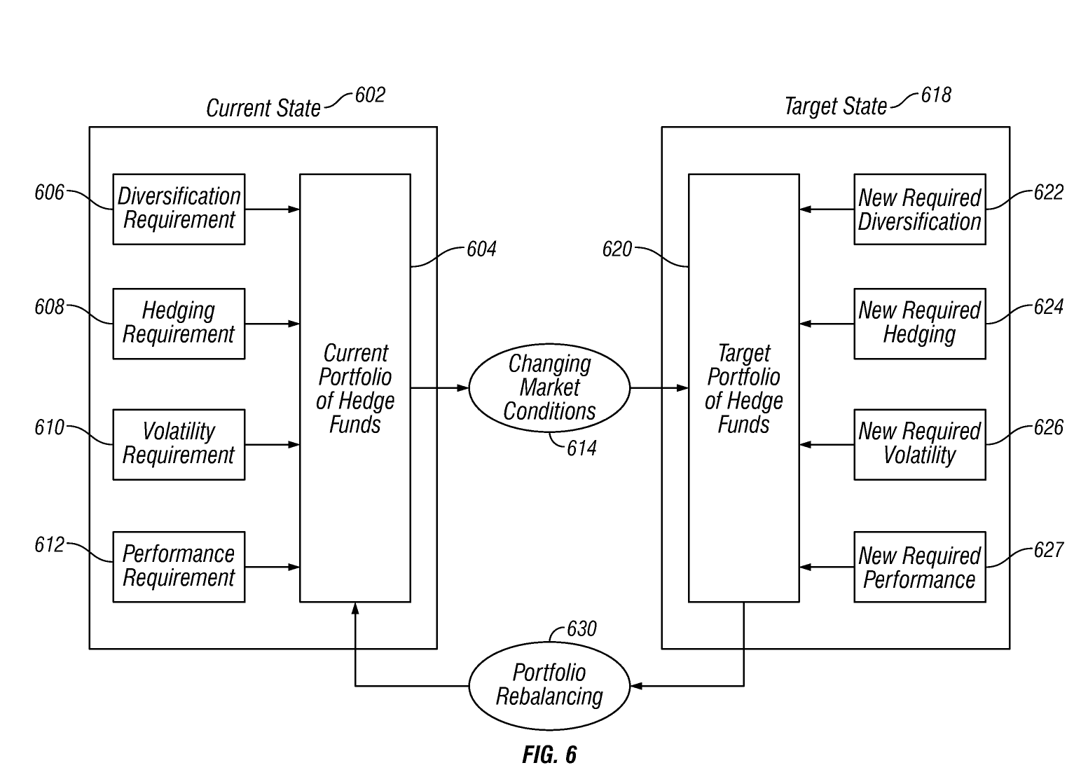

FIG. 6 illustrates a conceptual view of portfolio rebalancing in accordance with an embodiment of the invention. A current state of a portfolio 602 comprises a current portfolio of hedge funds 604. As described above, along with the current portfolio of hedge funds is a set of possible requirements for changes to the current portfolio allocation, the set comprising a diversification requirement 606, hedging requirement 608, volatility requirement 610, and a performance requirement 612. Given particular changing market conditions 614, embodiments herein perform portfolio rebalancing 630 using a target state 618 of the portfolio. Target state 618 comprises a target portfolio of hedge funds 620, along with an associated set of any of new required diversification 622, new required hedging 624, new required volatility 626, and new required performance 628.

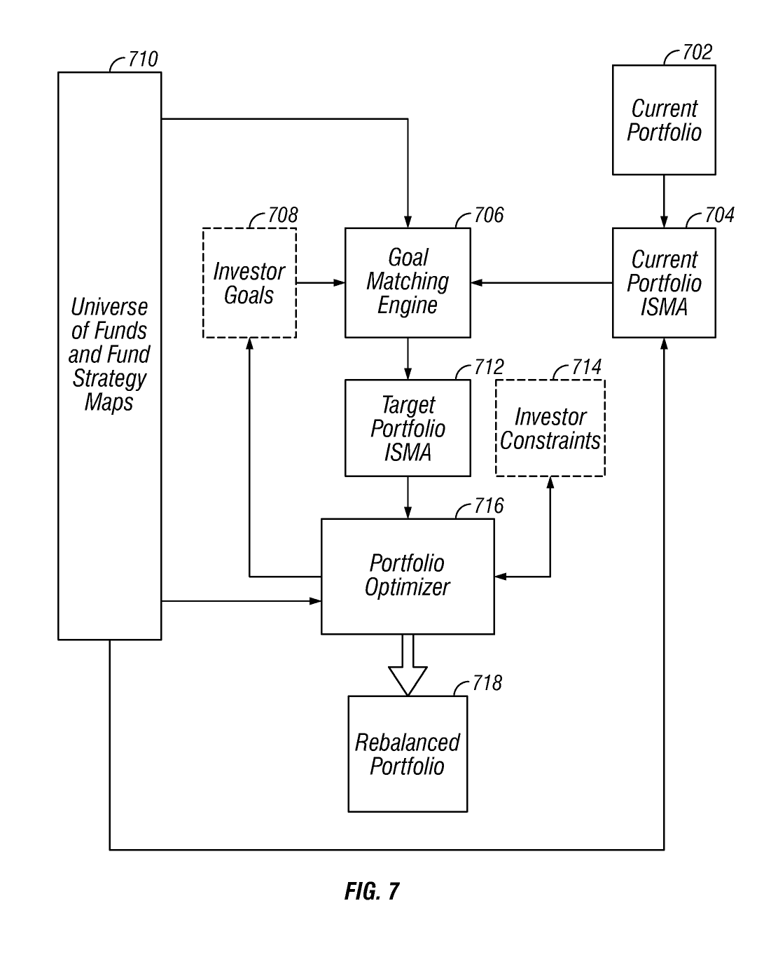

An overview of creating rebalanced and/or optimized proposed allocations in accordance with an embodiment can be understood with reference to FIG. 7, a flow diagram of an overview of a portfolio rebalancing process.

In accordance with an embodiment, the first step in the above portfolio rebalancing process overview is deriving or generating a current portfolio ISMA 704 from a current portfolio 702, as described previously.

As a second step in accordance with the embodiment, a goal matching engine 706 takes the investor's goals 708, current portfolio ISMA 704, and the universe of fund strategy maps 710 as input and produces a target portfolio ISMA 712. Goal matching engine 706 includes a set of business rules that are constructed and configured in accordance with the achievement of a specific goal or set of goals, such as for example from investor's goals 708. For example, eliminating the exposure to South America redistributes the values in the geography category so that the value of South America is reduced to zero in target portfolio ISMA 712. Hedging against market declines may result in both increasing the Market Neutral Strategic Approach as well as increasing the Short and Long/Short values in the Transaction Direction Category.

The third step in the above process in accordance with the embodiment is to determine or generate investor constraints 714 that place limits on specific performance and operational metrics for selected hedge funds, as well as explicit inclusion or exclusion of hedge funds and/or hedge fund strategies. Examples of possible constraints include but are not limited to the following:
Fund Preference Constraints
   Funds explicitly included/excluded
Strategy Preference Constraints
   Strategies explicitly included/excluded
Performance Constraints
   Minimum three year CAR
   Minimum twelve month return
   other performance constraints
Risk Constraints
   Maximum standard deviation over the past twelve months
   Maximum Sharpe ratio over the past three months
   other risk constraints
Diversification Constraints
   Maximum allocation in a single fund
   Maximum number of funds
   other diversification constraints

The last step in the process is to submit target portfolio ISMA 712, investor constraints 714, and universe of funds and fund strategy maps 710 to a portfolio optimizer 716 to produce a rebalanced portfolio 718. Should a rebalanced portfolio not be feasible based on for example stringent and/or conflicting investor constraints and goals, portfolio optimizer 716 proposes options for tempered goals and/or relaxed constraints that would result in a rebalanced portfolio.

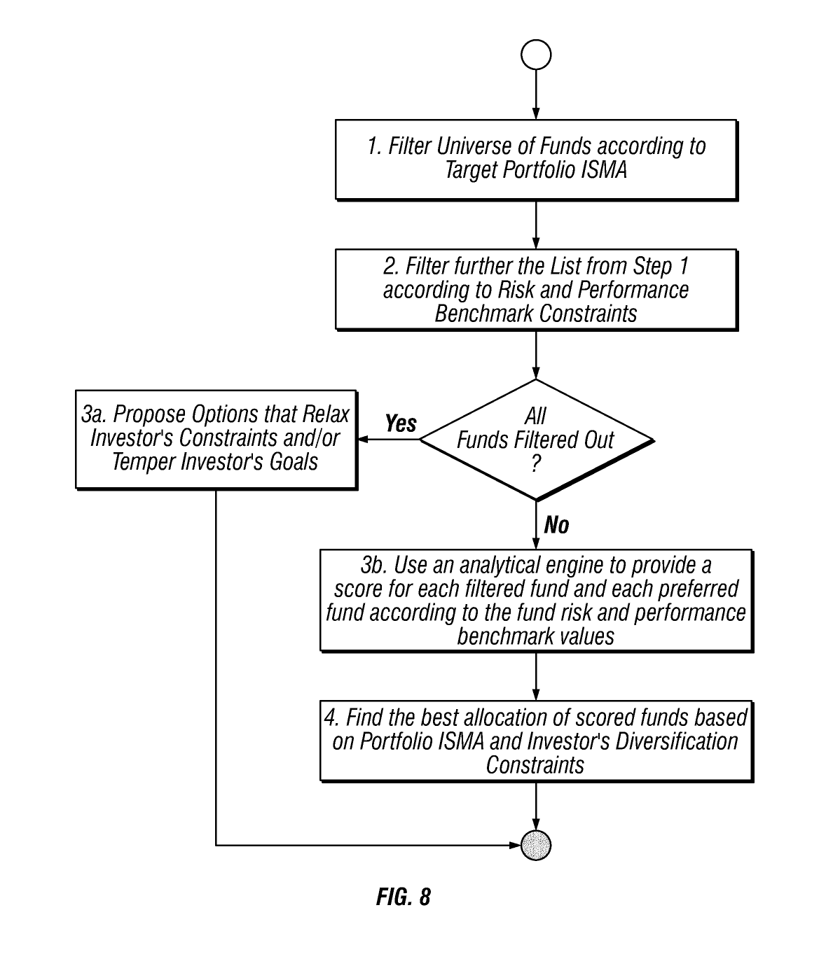

An embodiment provides a portfolio optimizer process, which can be understood with reference to FIG. 8, a flow diagram of a portfolio optimizer process overview.

Step 1 of the portfolio optimizer process includes filtering the universe of funds according to the target portfolio ISMA. Funds with Fund ISMA that do not conform to the target portfolio ISMA are filtered out. For example, if a target portfolio ISMA has a zero value in Arbitrage, then all funds with a corresponding Fund ISMA that includes an Arbitrage percentage value over a certain low threshold, e.g. 5%, are filtered out.

In Step 2, the filtered funds are filtered again according to the Investor's risk and performance benchmark constraints. For example, if an investor benchmark for a 3-year CAR is 25%, then all funds with a 3-year CAR less than 25% are filtered out.

Should no fund be found that meets the above constraints, i.e. funds in the universe of funds are filtered out, the portfolio optimizer then proposes options that relax the investor's constraints and/or temper the Investor's goals (Step 3a).

Investor's constraints and/or goals are adjusted and the portfolio rebalancing process starts again.

On the other hand, should funds be found that meet the above constraints, these funds are added to the preferred funds and each of these filtered and preferred funds is assigned a normalized score by an analytical engine (Step 3b). In an embodiment, high scores correspond to a combination of high performance benchmark values and low risk benchmark values and low scores correspond to a combination of low performance benchmark values and high risk benchmark values.

Step 4 finds or determines the best allocation of funds based on the target portfolio ISMA and investor diversification requirements. For example, should the investor's constraints include a maximum of 15 funds in the proposed allocation and the number of funds that are scored in Step 3b are 26, then the 15 funds with the highest scores are selected.

The product of the above-described portfolio optimizer is a rebalanced portfolio of hedge funds which is the output of this application in accordance with embodiments discussed herein.

### An Example Machine Overview

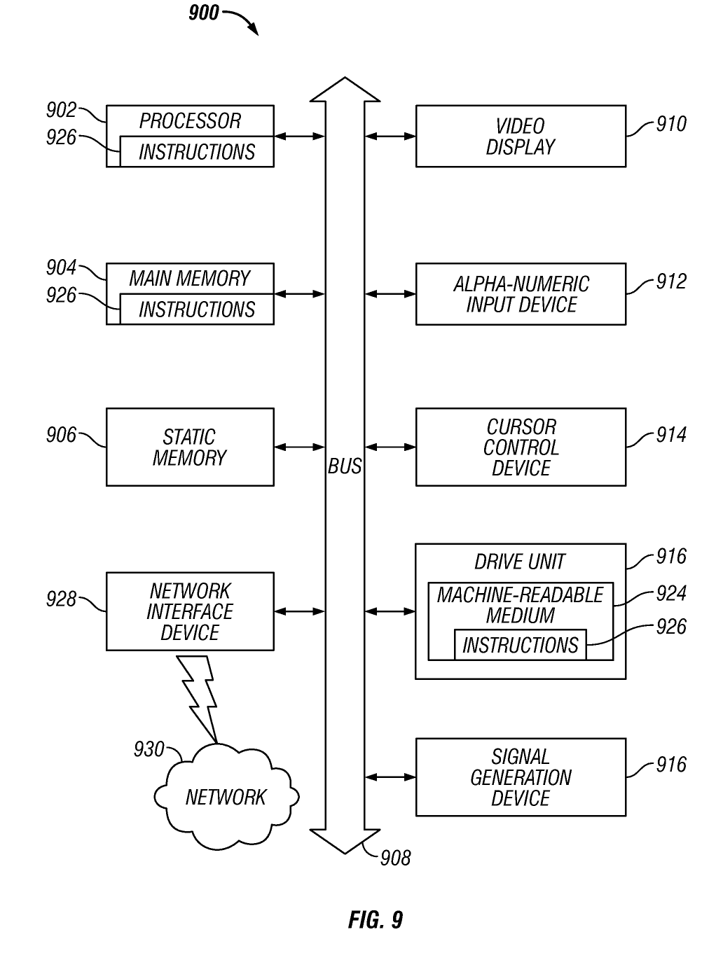

FIG. 9 is a block schematic diagram of a system in the exemplary form of a computer system 900 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 900 includes a processor 902, a main memory 904 and a static memory 906, which communicate with each other via a bus 908. The computer system 900 may further include a display unit 910, for example, a liquid crystal display (LCD) or a cathode ray tube (CRT). The computer system 900 also includes an alphanumeric input device 912, for example, a keyboard; a cursor control device 914, for example, a mouse; a disk drive unit 916, a signal generation device 918, for example, a speaker, and a network interface device 928.

The disk drive unit 916 includes a machine-readable medium 924 on which is stored a set of executable instructions, i.e. software, 926 embodying any one, or all, of the methodologies described herein below. The software 926 is also shown to reside, completely or at least partially, within the main memory 904 and/or within the processor 902. The software 926 may further be transmitted or received over a network 930 by means of a network interface device 928.

In contrast to the system 900 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users to perform analysis and mapping of hedge fund investment strategies on such internet-enabled or other network-enabled devices, servers, or clients. It further should be appreciated that one or more cloud computing embodiments include performing analysis and mapping of hedge fund investment strategies using mobile devices, tablets, and the like, as such devices are becoming standard consumer devices. In an embodiment, the front-end may be implemented in a mobile device or on a computer and the back-end may be implemented in a cloud-based server.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-implemented method for portfolio analysis and mapping of hedge fund investment strategies, comprising the steps of:
receiving a hedge fund portfolio comprising a current allocation, wherein the current avocation comprises a list of hedge funds and an amount invested in each hedge fund and wherein each hedge fund has an investment strategy;
mapping each hedge fund to a fund investment strategy map assignment comprising fund category values by assigning the amount invested to each of the fund category values; and
generating a portfolio investment strategy map assignment by aggregating said fund investment strategy map assignments and determining and providing a breakdown of the portfolio into relevant portfolio categories, thereby providing exposure of the portfolio in each category,
wherein one or more steps are performed on at least a processor coupled to at least a memory.

2. The method of claim 1, wherein said each fund category corresponds to a dimension in a multi-dimensional space of multiple, orthogonal dimensions such that each fund investment strategy is mapped to a point or locus of points in said multi-dimensional space, such that any relative overlap and complementation of a collection of said strategy maps can be readily and automatically determined with a reasonable degree of precision.

3. The method of claim 2, wherein said dimensions comprise:
domain, which characterizes target subject matter or scope of each fund's investments;
strategic approach, which characterizes target situational aspects driving said fund's investments; and
transactional structure, which characterizes a specific asset structure targeted for acquisition or disposal by said fund.

4. The method of claim 3, wherein the domain dimension has fund category values comprising:
economic level;
geography;
market type;
sector; and
asset type.

5. The method of claim 4, wherein each fund category value has a second level of values comprising:
macro, micro, and any for said economic level;
global, Asia, Europe, North America, and South America for said geography value;
mature, emerging, and any for said market type value;
agriculture, energy, health care, materials, technology, and any for said sector value; and
quality, distressed, and any for said asset type.

6. The method of claim 3, wherein the strategic approach dimension has fund category values comprising:
activist;
market neutral; and
multi-strategy.

7. The method of claim 3, wherein the transaction structure dimension has fund category values comprising:
instrument; and
direction.

8. The method of claim 7, wherein each fund category value has a second level of values comprising:
all available instruments for said instrument; and
at least long and short for said direction.

9. A computer-implemented method for portfolio rebalancing and optimization, comprising the steps of:
receiving a current portfolio investment strategy map assignment for a current portfolio;
receiving, by a receiving processor, investor's goals, said portfolio investment strategy map assignment, and a universe of fund strategy maps as input and generating, by said processor, a target portfolio investment strategy map assignment;
determining investor constraints that place limits on specific performance and operational metrics for selected hedge funds, as well as explicit inclusion or exclusion of hedge funds or hedge fund strategies; and
receiving, by a portfolio optimizer processor, said target portfolio investment strategy map assignment, said investor constraints, and said universe of funds and fund strategy maps and generating, by said portfolio optimizer processor, a rebalanced portfolio when feasible;
wherein one or more steps are performed on at least a processor coupled to at least a memory.

10. The method of claim 9, wherein said portfolio investment strategy map assignment is the portfolio investment strategy map assignment generated in claim 1.

11. The method of claim 9, wherein said receiving processor further comprises a set of business rules that are constructed and configured in accordance with the achievement of a specific goal or set of goals.

12. The method of claim 9, wherein said investor constraints comprise:
fund preference constraints;
strategy preference constraints;
performance constraints;
risk constraints; and
diversification constraints.

13. The method of claim 12, wherein:
said fund preference constraints comprises:
funds explicitly included/excluded;
said strategy preference constraints comprises:
strategies explicitly included/excluded;
said performance constraints comprise
minimum three year CAR;
minimum twelve month return; and
other performance constraints;
said risk constraints comprise:
maximum standard deviation over the past twelve months;
maximum Sharpe ratio over the past three months; and
other risk constraints; and
diversification constraints comprise:
maximum allocation in a single fund;
maximum number of funds; and
other diversification constraints.

14. The method of claim 9, wherein said portfolio optimizer performs the following process:
filtering said universe of funds according to said target portfolio investment strategy map assignment, wherein funds in an associated fund investment strategy map assignment that do not conform to said target portfolio investment strategy map assignment are filtered out;
filtering said remaining funds according to investor's risk and performance benchmark constraints;
when filtered funds are found in said universe of funds, assigning, by a processor, each of said funds a score; and
determining a best allocation of said filtered funds based on said target portfolio investment strategy map assignment, investor diversification requirements, and said scores.

15. An apparatus for portfolio analysis and mapping of hedge fund investment strategies, comprising:
a memory;
at least one processor in communication with said memory and configured to issue program instructions stored in said memory, wherein said at least one processor issues instructions to:
receive a hedge fund portfolio comprising a current allocation, wherein the current allocation comprises a list of hedge funds and an amount invested in each hedge fund and wherein each hedge fund has an investment strategy;
map each hedge fund to a fund investment strategy map assignment comprising fund category values by assigning the amount invested to each of the fund category values; and
generate a portfolio investment strategy map assignment by aggregating said fund investment strategy map assignments and determining and providing a breakdown of the portfolio into relevant portfolio categories, thereby providing exposure of the portfolio in each category.

16. An apparatus for portfolio rebalancing and optimization, comprising:
a memory;
at least one processor in communication with said memory and configured to issue program instructions stored in said memory, wherein said at least one processor issues instructions to:
receive a current portfolio investment strategy map assignment for a current portfolio;
receive, by a goal matching engine processor, investor's goals, said portfolio investment strategy map assignment, and a universe of fund strategy maps as input and generate, by said goal matching engine processor, a target portfolio investment strategy map assignment;
determine investor constraints that place limits on specific performance and operational metrics for selected hedge funds, as well as explicit inclusion or exclusion of hedge funds or hedge fund strategies; and
receive, by a portfolio optimizer processor, said target portfolio investment strategy map assignment, said investor constraints, and said universe of funds and fund strategy maps and generate, by said portfolio optimizer processor, a rebalanced portfolio when feasible.
